(19) United States
(12) Patent Application Publication
(10) Pub. No.: US 2008/0190924 A1
(43) Pub. Date: Aug. 14, 2008

(54) Medical sharps container

(75) Inventors: Sergey Bobrov, Aurora, IL (US); Steven T. Umlor, Belvidere, IL (US)

Correspondence Address: RATNERPRESTIA, P O BOX 980, VALLEY FORGE, PA, 19482-0980, US

(73) Assignee: Sherwood Services, AG

(21) Appl. No.: 11/706,916

(22) Filed: Feb. 13, 2007

(51) Int. Cl. B29C 45/16; B65D 3/22; B32B 7/00; B65D 39/00; B32B 3/26

(52) U.S. Cl. 220/62.22; 264/510; 428/36.5; 428/220; 428/213; 428/304.4

(57) ABSTRACT

A medical waste container includes a reduced-weight section having a high density outer skin layer, a high density inner skin layer, and a cellular core layer between the outer skin layer and inner skin layer. A method for manufacturing a medical waste container includes the steps of combining a thermoplastic polymer with a endothermic chemical blowing agent, heating the polymer and blowing agent to form a melted mixture, maintaining the mixture under conditions that prevent or substantially prevent activation of the blowing agent, injecting the mixture into a mold having a mold chamber and chamber walls, the mold being at a pressure that is sufficiently low to activate the blowing agent and initiate cell formation in the mold chamber, and cooling the melted mixture in the mold to form skin layers in the mixture where the mixture contacts the chamber walls.

### FIELD OF THE INVENTION

This invention relates to the manufacturing of impact-resistant and puncture-resistant thermoplastic articles having reduced weight. More specifically, this invention is directed to a process for manufacturing medical waste containers and sharps containers comprising a foamed thermoplastic polymer that features a microcellular foam core.

### BACKGROUND OF THE INVENTION

In hospitals, clinics, and similar medical institutions, contamination continues to be of utmost concern. The prevention of the spread of communicable diseases is a major priority; therefore, disposable, single-use, patient care products have become prevalent. Such items are contaminated, once used, and can readily transmit disease. These items include such devices as hypodermic needles, intravenous needles, razors, scalpel blades, or other sharps—all of which are required to be disposed of at their point of usage under current guidelines of the United States Centers for Disease Control.

Various disposal containers for medical wastes have been proposed for the purpose of providing a container which has a high resistance to piercing by sharps, yet which is storable and transportable. Components used to assemble such containers are typically prepared from moldable thermoplastic materials. The containers are generally required to meet a number of performance criteria, including standards for impact resistance, puncture resistance and leak resistance. Other parameters that should be considered during the manufacture of such containers include warping, concentrated stresses and dimensional stability. Dimensional instability and/or warping can prevent components such as molded lids from closing or functioning properly.

It is desirable to manufacture sharps containers with thin walls. By keeping the wall thickness small, the amount of material that goes into each product is decreased, and the resulting weight of the product is reduced. Unfortunately, components manufactured from ultra thin-walled thermoplastic materials can exhibit a significant reduction in impact resistance and may be susceptible to puncture by sharp objects. Reducing the wall thickness of a molded part can therefore result in a container that fails to meet standards for impact resistance, puncture resistance, or other performance criteria. Accordingly, it is desirable to retain the material properties of moldable thermoplastic components while reducing the weight of the components.

### SUMMARY OF THE INVENTION

In view of the foregoing, a sharps container in accordance with the invention includes at least one component or component section that provides impact resistance and needle puncture resistance with reduced weight.

According to one aspect of the invention, a medical waste container includes a wall and at least one reduced-weight section of the wall formed of a foamed thermoplastic polymer. The at least one reduced-weight section of the wall includes an outer skin layer, an inner skin layer, and a cellular core layer between the outer skin layer and inner skin layer. The cellular core layer has a density lower than a density of the outer skin layer and a density of the inner skin layer. The reduced-weight section of the wall has a needle puncture resistance of at least about 2.8 lbf.

According to another aspect of the invention, a method for manufacturing a container includes the steps of combining a thermoplastic polymer with an endothermic chemical blowing agent, heating the polymer and blowing agent to form a melted mixture, maintaining the mixture under conditions that substantially prevent activation of the blowing agent, injecting the mixture into a mold chamber of a mold, maintaining the mold chamber at a pressure that is sufficiently low to promote cell growth in the mold chamber, and cooling the melted mixture in the mold to form skin layers in the mold, wherein the cell formation occurs between the skin layers to form a cellular core layer between the skin layers.

### BRIEF DESCRIPTION OF THE DRAWINGS

The invention will be described with reference to the exemplary embodiments illustrated in the figures of which:

FIG. 1 is a perspective view of an exemplary embodiment of a medical sharps container in accordance with the present invention.

FIG. 2 is an elevation view of the container shown in FIG. 1, with a portion broken away to expose a partial cross-section.

FIG. 3 is a magnified cross-sectional view of the container shown in FIG. 2.

FIG. 4 is a flow chart summarizing an exemplary embodiment of a generalized method for manufacturing an impact-resistant article in accordance with the present invention.

FIG. 5 is a flow chart summarizing a variant of the method summarized in FIG. 4 for manufacturing an impact-resistant article in accordance with the present invention.

FIG. 6 is a schematic view of an exemplary embodiment of an injection mold system for manufacturing an impact-resistant article in accordance with the present invention.

FIG. 7 is a graph that illustrates main effect response for puncture resistance based on different combinations of parameters.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Referring generally to the figures, an exemplary embodiment of a medical waste container 20 includes a wall 24 and at least one reduced-weight section of the wall formed of a foamed thermoplastic polymer. The reduced-weight section of the wall includes an inner skin layer 26, an outer skin layer 28, and a cellular core layer 30 between the inner skin layer 26 and outer skin layer 28. The cellular core layer 30 has a density lower than a density of the outer skin layer 28 and a density of the inner skin layer 26, and the reduced-weight section of the wall has an average needle puncture resistance of at least 3.4 lbf, with the minimum needle puncture resistance of at least 2.8 lbf for a single data point.

The outer and inner skin layers 26 and 28 have a thickness of between about 0.005 in. and about 0.050 in., or more specifically about 0.015 in. and about 0.035 in., and the core layer has a thickness of between about 0.005 in. and about 0.050 in., or more specifically, about 0.015 in. and about 0.035 in. The reduced-weight section has a skin/core/skin thickness ratio between about 1:1:1 to about 1:10:1, or more specifically about 3:5:3 and comprises a total thickness of about 0.07 in.

The reduced-weight section includes a foamed polyolefin prepared by injection molding an admixture of polyolefin and an endothermic chemical blowing agent. The polyolefin is low density polyethylene, linear low density polyethylene, high density polyethylene, polypropylene, ethylene/alpha-olefin copolymers, propylene/alpha-olefin copolymers, polyethylene terpthalate, polyvinyl chloride or blends thereof. At least one additive such as stabilizers, pigments, coloring agents, fillers, nucleating agent, fire-retarding agents, antistatic agents, lubricants, non-stick agents, or mixtures thereof, are added to the foamed polyolefin.

The reduced-weight section has a reduced weight percentage of at least about 10% and exhibits no substantial warping (e.g., warpage that would either cause a reduction in performance or be perceived as poor workmanship). It also has a needle puncture resistance of between about 3.4 lbf to about 7.0 lbf, as described in greater detail below.

A method for manufacturing the medical waste container includes combining a thermoplastic polymer with an endothermic chemical blowing agent. The polymer and blowing agent are then heated to form a molten mixture. The mixture is maintained under conditions that substantially prevent activation of the blowing agent. To be more specific, the injection pressure exerted on the material as it is injected into the mold cavity is sufficient to inhibit cellular growth.

As the molten material flows into the mold chamber, the temperature differential between the walls of the mold chamber and the molten materials cools the material to form a skin on the walls. As the pressure was sufficient to inhibit cellular growth during the injection of the molten material, the skins formed on the mold chamber walls (e.g., inner skin, outer skin) will not comprise a cellular structure. Once the skin is formed, the skin insulates the molten material that is disposed between the inner skin and the outer skin, which then takes an increased amount of time to reach a temperature below the specific melting temperature of the resin and solidify.

Once the desired amount of molten material has been injected into the mold chamber, the mold chamber is altered to a state that is sufficient to activate the blowing agent and initiate cell formation in the mold chamber. If a volume of material was injected into the mold that was less than the total volume of the mold chamber, the alteration of the state that activates the blowing agent and initiates cell formation can cause the molten material to flow into all portions of the mold chamber, thereby forming the entire inner skin and outer skin.

The mixture is high speed injected into a mold chamber of a mold while the mold chamber is maintained at a pressure that is sufficiently low to activate the blowing agent and initiate cell formation in the mold chamber. While the mixture is expanding in the mold chamber due to the decomposition reaction of the endothermic chemical blowing agent, the pressure in the mold chamber increases and the temperature of the molten mixture in the pre-wall proximity of the mold decreases. After a pre-determined hold time, the mold cavity is decompressed by shifting the screw of the injection unit backward. This reverse motion of the screw draws pressure from the mold cavity, further promoting cell growth. The melted mixture is cooled in the mold to ultimately form skin layers in the mixture where the mixture contacts chamber walls of the mold, wherein the cell formation occurs between the skin layers to form a cellular core layer between the skin layers.

The chamber walls are maintained at a temperature below the melting point of the mixture by, for example, maintaining the chamber walls at a substantially constant temperature of between about 80° F. and about 125° F., or preferably between about 95° F. and about 120° F., depending on the material selected for forming the container. The mixture is injected into the mold chamber at an injection velocity. The injection velocity may vary significantly based on a number of parameters. For example, the injection velocity may be as little as about 0.25 in/sec or slower, or as much as about 25 in/sec, or faster. Applicant has used injection velocities of between about 3.3 in./sec. and about 5.0 in./sec, with satisfactory results. The pressure in the mold chamber is reduced after injection of the mixture into the mold chamber to promote cell formation in the core layer. The mixture is held at a high pressure, for example a hydraulic pressure of between about 1,000 psi and about 2,000 psi, in the injection unit in order to prevent premature decomposition. The decompression of the molten mixture promoted by backward motion of the screw of between a small distance relative to the barrel length. For example, the screw may be retracted by a distance of about 1 mm to about 5 mm to decompress the mold cavity. Skin layers are formed in the mixture, and may include a first skin layer and a second skin layer having a thickness greater than the first skin layer. The method can include combining the thermoplastic polymer and the endothermic chemical blowing agent with at least one additive such as stabilizers, pigments, coloring agents, fillers, nucleating agent, fire-retarding agents, antistatic agents, lubricants, non-stick agents, or mixtures thereof.

In one exemplary process of the present invention, an impact resistant and puncture resistant component is formed from a foamed thermoplastic polymer by an injection molding process. In the injection molding process, an admixture of the thermoplastic polymer and at least one endothermic chemical blowing agent is heated and homogenized into a mixture. The mixture is heated above the activation temperature of the chemical blowing agent but kept at a sufficiently high pressure to prevent foaming. The mixture is then fed into a mold cavity at which time the mixture undergoes a significant drop in pressure so that foaming takes place in the mold cavity. The foamed thermoplastic conforms to the particular shape of the mold cavity, and is permitted to cool and solidify. Thereafter, the foamed thermoplastic article is ejected from the mold.

Suitable thermoplastic polymers and co-polymers may have amorphorous, semi-crystalline or crystalline morphologies. Examples of such thermoplastic polymers and co-polymers include, but are not limited to: cellulose propionate, triacetates, ethyl cellulose, polyoxymethylene, polyisobutylene, polymethylpentene, polybutene, polypropylene, polyethylene, polystyrene, acrylonitrile copolymer, polyacrylate, polyetheretherketone, polymethacrylate, polyvinylchloride, polyvinylidene chloride, polyvinyl acetate, polyvinyl alcohol and acetal, polyvinyl ether, polyvinylidene fluoride, polytetrafluoroethylene, polyphenylene oxide (such as “Noryl™” commercially available from General Electric), polyethylene:tetrafluoroethylene (such as “Tefzel™” commercially available from DuPont), polyamide, polyesteramide, thermoplastic elastomers, such as polyurethane, linear polyesters, polycarbonates, silicones, polyetherimide (such as “Ultem™” commercially available from General Electric), and polyimide. According to one embodiment of the invention, the thermoplastic polymers and co-polymers are those having a glass transition temperature above 150° C. According to another embodiment of the invention, the thermoplastic polymer has a melt index of more than about 10 and less than about 40. As used herein, the melt index refers to the number of grams of polymer that can be pushed out of a capillary die of standard dimensions (Diameter: 2.095 mm, Length: 8.0 mm) under the action of standard weight (2.16 kg for polyethylene, at 190° C.) in 10 minutes (ASTM Standard 1238). The usual melt index range is from less than 1.0 (called fractional) to more than 25 (up to 100 for injection molding). For polypropylene, it is also referred to as the melt flow rate and the standard temperature is 230° C.

At least one endothermic chemical blowing agent is used in accordance with exemplary embodiments of the invention. The endothermic chemical blowing agent, after compounding as an admixture with the thermoplastic polymer, undergoes a chemical reaction in the polymer material causing formation of a gas. The gaseous decomposition products are dispersed in the polymer melt. Chemical blowing agents generally are low molecular weight organic compounds that decompose at a critical temperature and release a gas such as nitrogen and carbon dioxide.

Suitable examples of endothermic blowing agents that can be used include, but are not limited to, ammonium bicarbonate, sodium bicarbonate, carbonic acid, sodium carbonate, citric acid, citric acid mixtures with carbonates or bicarbonates, polycarboxylic acids, Hydrocerol™, Safoam™ (Available from Reedy International Corporaion) and Foamazol® (Available from Bergen International). According to one embodiment of the invention, the activation temperature (also referred to as the decomposition temperature) is greater than about 150° C., including but not limited to between about 150° to about 500° C.

According to one embodiment of the invention, the chemical blowing agent produces a foamed thermoplastic polymer having a substantially uniform closed cell structure. To obtain a uniform cell structure in the foamed thermoplastic polymer, the gaseous decomposition products of the chemical blowing agent are substantially uniformly dispersed in the melted thermoplastic polymer. Some factors influencing this process include, but are not limited to for example, the particle size of the chemical blowing agent, the dispersive properties of the injection molding equipment or admixing equipment, the decomposition rate of the chemical blowing agent and the melt viscosity of the thermoplastic resin.

According to a separate embodiment of the invention, the chemical blowing agent produces a foamed thermoplastic polymer having a non-uniform or open cell structure. For example, under more violent foaming or decomposition conditions, the cells of the polymer rupture or become interconnected and an open-cell material results.

The amount of endothermic chemical blowing agent may vary. Suitable amounts of endothermic blowing agent include a weight percent of approximately 0.1% by weight to approximately 1.5% by weight, including but not limited to for example approximately 0.2% to 1.0% by weight, and approximately 0.2% to 0.5% by weight, based on the weight of the thermoplastic polymer.

The melted mixture is fed into a mold cavity that immediately cools a portion of the mixture. The walls of the mold cavity are carefully maintained within a temperature range below the lowest melting point of the mixture. The lower temperature of the cavity walls immediately solidifies a portion of the mixture in contact with or in immediate proximity to the walls, but not the entire mixture. As the portion of the mixture in contact with the walls cools, that portion gradually thickens into a more viscous layer along the outer extremities of the cavity. The viscous layers gradually solidify into “skin layers” having a relatively high density. The portion of the melt toward the center of the flow, i.e. the portion that is not in proximity to the cavity walls, retains more heat fluid, allowing cells to form in the core portion of the mixture. The differentiated melt flow contributes to shear flow which, in turn, creates additional heat due to inter layer friction. Generated heat induces decomposition of chemical blowing agent and cell initiation and growth in the center of the melt between the skin layers.

After the first stage of injection, the molten mixture typically fills a portion of the mold, for example between about 60% to about 95% of the mold volume. Back pressure is held for a brief amount of time on the molten mixture, at which time the molten mixture continues to advance into the cavity. After the brief hold time, the pressure within the mold cavity is reduced, allowing the molten mixture to completely fill the cavity. The reduction in pressure continues and enhances the process of cell formation in the core. In an injection molding machine, for example, the pressure in the mold cavity can be reduced in a controlled manner by drawing the screw rearwardly from the injection port. Drawing the screw rearwardly has been found to effectively decompress the mold cavity without distorting the ultra-thin wall structure, as will be explained in more detail below.

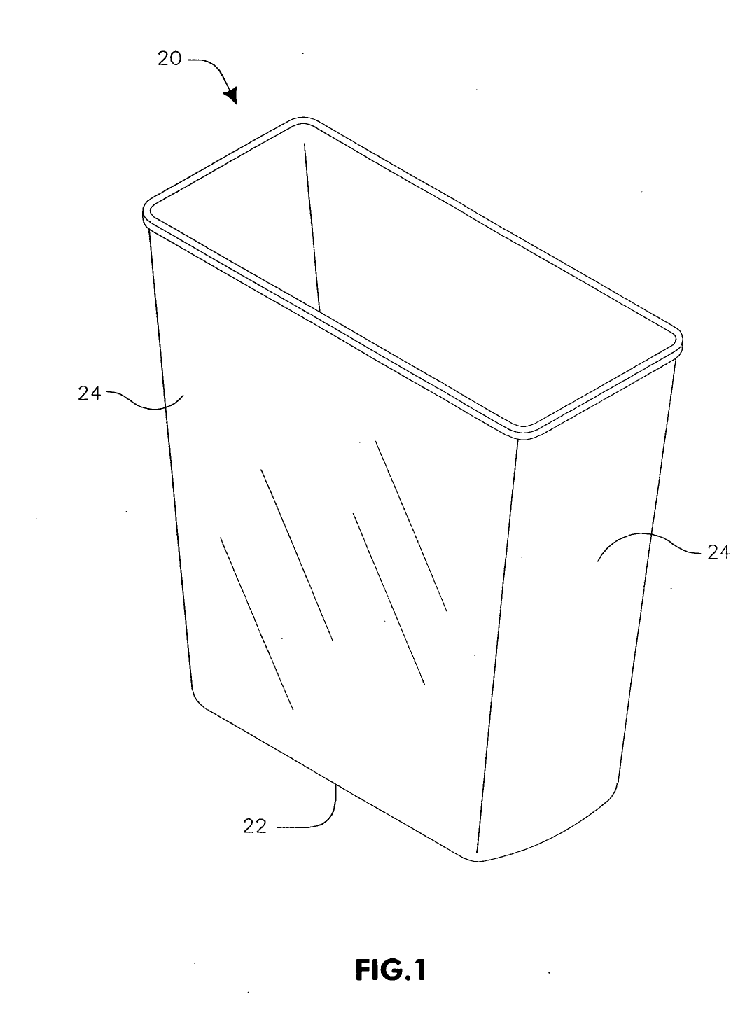

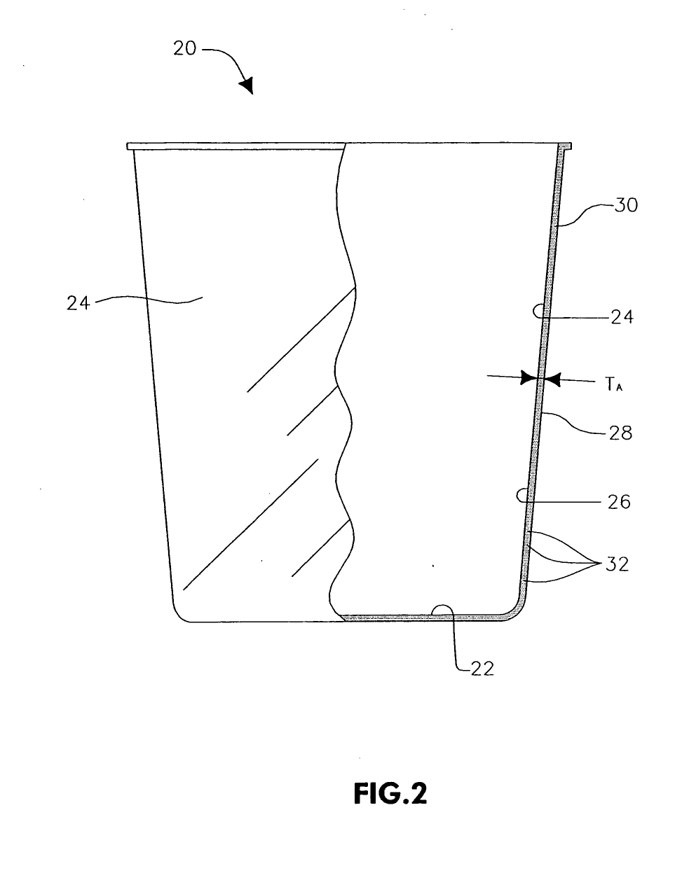

The above-described process can be used to form a variety of impact-resistant, reduced-weight components. Referring now to FIGS. 1 and 2, a receptacle or bucket 20 for a medical sharps container is shown. The receptacle 20 has a generally rectangular body having a bottom wall 22 and four side walls 24 which extend upwardly from the bottom wall. It will be understood that the receptacle configuration shown in FIGS. 1 and 2 is an exemplary configuration and is not intended to represent the only container configuration for which the invention is intended. A number of other container shapes, configurations and sizes may be formed in accordance with the present invention. For example, the process may be used to manufacture sharps containers as large as 30 gallons, or larger.

Receptacle 20 is a foamed thermoplastic article, which offers substantial impact resistance in combination with a reduced weight, as compared to similar components formed by other processes. The bottom wall 22 and sidewalls 24 of receptacle 20 have a multi-layer structure that includes a cellular core surrounded by solid or substantially solid panels or skin layers. The cellular core creates small void spaces within the walls. The presence of void spaces within the walls of the receptacle results in less molded material per unit volume, as compared to a solid-walled receptacle.

Historically, a reduction in density would create a concern regarding the structural integrity of the container. That is, the presence of void spaces within the wall structure would be expected to create failure points that compromise the impact resistance or puncture resistance of the receptacle. It has been discovered, however, that foamed thermoplastic articles made in accordance with the present invention have comparable impact resistance and puncture resistance as solid-walled thermoplastic components, even though the amount of material by weight is reduced by as much as 5% or more. This is due in large part to the skin layers, which have been found to provide an impact resistance and puncture resistance that are comparable to conventional injection molded parts having solid homogenous walls.

ASTM-F2132 provides a test procedure and performance requirement for the puncture resistance of materials used in the construction of containers for discarded medical waste, needles and other sharps. This test specification establishes (1) the average puncture force and (2) a minimum value of puncture force that container materials must withstand when following the test procedure. A medical sharps and waste disposal container may be manufactured in accordance with the present invention to exhibit an average puncture force and minimum puncture force that are comparable to solid-walled containers, as will be described below in greater detail.

A test procedure that measures impact strength is ASTM-D5628, which determines the relative ranking of materials according to the energy required to crack or break flat, rigid plastic specimens under various specified conditions of impact of a free-falling dart. Another test for impact strength is to drop a filled, medical sharps and waste disposal container from a predetermined height (the height depends on the size and weight of the container) onto a hard surface. The container fails this impact strength test when the impact of the drop causes a medical sharp or other medical waste to escape from the container. For example, a filled, 2 gallon medical sharps disposal container weighing about 1.0 lbs was dropped from a height of 36 inches. If no medical sharps or medical waste escaped from the container, either through a breach in a wall or the lid of the container, after being drop from the predetermined height, the container is determined to have a sufficient impact strength.

The thermoplastic article 20 preferably has at least one portion having an average cross-sectional thickness of about 0.100 inches, and more preferably about 0.070 inches. The article also includes a cellular core volume of at least about 20%, including but not limited to a core volume from about 20% to about 50%. Referring to FIG. 2, the foamed thermoplastic article is defined by cells. The article has a microcellular foam core having an average cell diameter less than about 100 microns, including but not limited to from about 30 to 100 microns, with the core foam thickness greater than from about three to about five times the average cell wall thickness.

The microcellular thermoplastic foam is preferably produced having average cell size of less than about 50 microns. In some embodiments, a particularly small cell size may be desired. In these embodiments, the foam has an average cell size of less than about 20 microns, more preferably less than about 10 microns, and still more preferably less than about 5 microns. The microcellular material preferably has a maximum cell size of about 100 microns. In embodiments where particularly small cell size is desired, the material can have a maximum cell size of about 50 microns, preferably about 25 microns, more preferably about 15 microns, more preferably about 8 microns, and still more preferably about 5 microns. A set of embodiments includes all combinations of these noted average cell sizes and maximum cell sizes. For example, one embodiment in this set of embodiments includes a microcellular material having an average cell size of less than about 30 microns with a maximum cell size of about 50 microns, and as another example an average cell size of less than about 30 microns with a maximum cell size of about 35 microns, etc. That is, microcellular material designed for a variety of purposes can be produced having a particular combination of average cell size and a maximum cell size preferable for that purpose. Control of cell size is described in greater detail below.

The foamed thermoplastic article features a multi-layer wall structure that includes an outer layer of relatively high density, an inner layer of relatively high density, and a cellular core layer of relatively low density in between the outer and inner wall layers. The outer wall layer and inner wall layer, also referred to as “skin layers”, provide solid portions that exhibit high impact resistance and high puncture resistance. The multi-layer wall construction has a skin/core/skin thickness profile in which the thickness of skin layers may be equal to or less than or greater than the thickness of the core layer. Where polypropylene was used, for example, a preferable skin/core/skin thickness profile was found to be about 0.015 in.-0.025 in./0.025 in.-0.050 in./0.015 in.-0.025 in.

Fully or partially foamed thermoplastic articles, in accordance with the invention, may contain a variety of additives. Such additives may or may not be in addition to hollow particles (syntactic foams) or filled foams. Suitable examples of additives include, but are not limited to: nucleating agents, solvents, emulsifiers, fillers, reinforcements, colorants, coupling agents, antioxidants, antistatic compounds, flame retardants, heat stabilizers, lubricants, mold release agents, plasticizers, preservatives, ultraviolet stabilizers and the like. These additives may vary according to the thermoplastic and the application or use of the foamed article. One or more additives may be contained in the foamed article.

The manufacture of foamed thermoplastic articles in accordance with the invention is carried out by thermal activation of at least one endothermic chemical blowing agent (also referred to as a foaming agent) using injection molding equipment, where the mold pressure is reduced. In accordance with one embodiment of the invention, an injection molding system includes a source of chemical blowing agent, a source of thermoplastic polymer, an extruder with an extruder barrel and a molding chamber.

Referring now to 3, a magnified cross-sectional view of container 20 in FIGS. 1 and 2 is provided. The cross-sectional view illustrates a section of the bottom wall 22. Preferably, the cross section of the container 20 is more or less the same throughout the bottom wall 22 and side walls 24 of the container. The wall section includes an interior wall layer or skin 26 and an exterior wall layer or skin 28. A cellular core 30 extends between the interior wall layer 26 and exterior wall layer 28. Core 30 includes a plurality of closed cells 32 separated by a matrix of material 34. Portions of matrix 34 that extend between adjacent cells form “cell walls” that preferably have an average thickness of no less than about 10 microns. The average cell size is preferably less than about 100 microns. As noted above, the preferred thickness profile of the outer skin layer, core layer and inner skin layer, respectively, is about 0.015 in.-0.025 in./0.025 in.-0.050 in./0.015 in.-0.025 in.

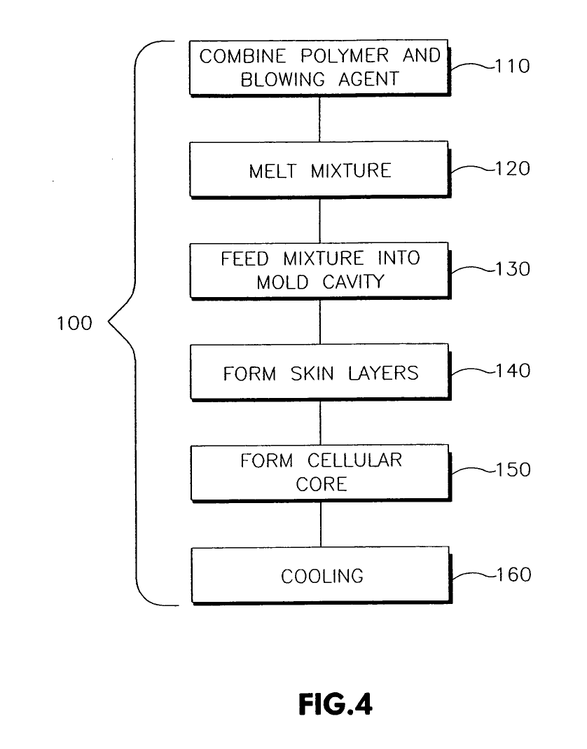

Referring now to FIG. 4, a general process 100 for manufacturing a thin-walled foamed thermoplastic article in accordance with an exemplary embodiment of the present invention is outlined in a block-flow diagram. A thermoplastic polymer and an endothermic chemical blowing agent are combined in step 110. The mixture is then melted to form a homogenized mixture in step 120. The melted mixture is then fed into a mold cavity in step 130. The shape of the mold corresponds to a thin-walled sharps container. Portions of the melt that flow in proximity to the mold cavity walls are allowed to cool and solidify into solid skin layers in step 140. The portion of the melt that flows between the skin layers is kept at a hotter temperature while the skin layers are solidified, allowing a foamed cellular core to develop between the skin layers in step 150. The melt is allowed to cool in step 160 until it hardens completely, after which the cooled article is removed from the mold.

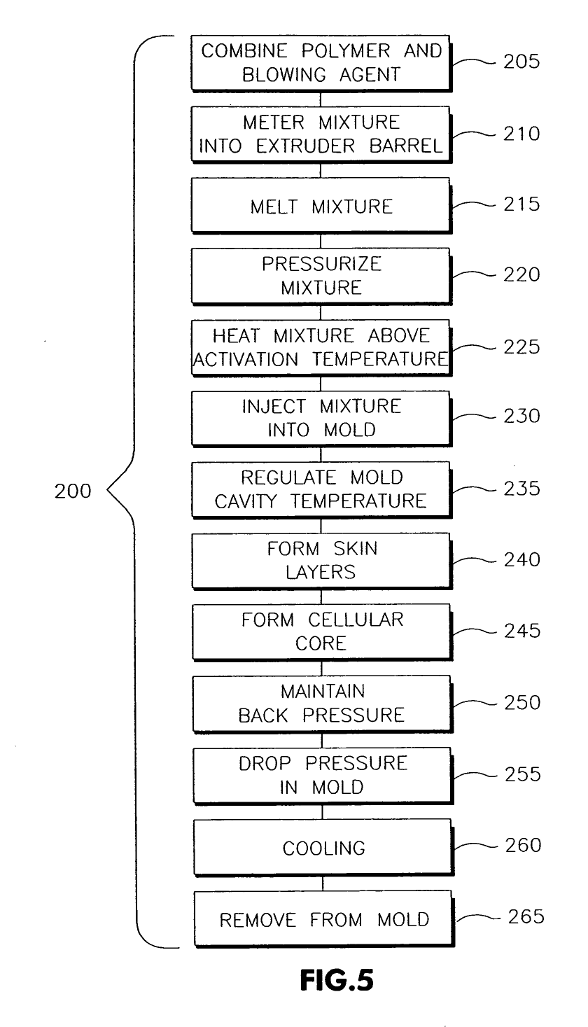

As noted above, the size and distribution of cells in the core layers, and the thickness of the skin layers can be controlled by adjusting a number of parameters. Referring to FIG. 5, a process 200 for manufacturing a foamed thermoplastic sharps container under low-pressure injection molding is outlined in a block-flow diagram. In process 200, a thermoplastic polymer and an endothermic chemical blowing agent are combined in step 205. For example, a thermoplastic polymer in pelletized form may be mechanically mixed with a chemical blowing agent in particulate form. The polymer and blowing agent may be blended in a mixer or automatic blending unit.

The combined polymer and blowing agent are then metered into an extruder barrel for an injection molding machine in step 210. The mixture may be metered gravimetrically into the flights of a screw rotating and moving axially in the barrel. The mixture is heated in the barrel in step 215 to melt the mixture. As the polymer melts with the blowing agent, the blowing agent gradually disperses through the melt, forming a homogenized mixture. The temperature in the load portion of the barrel is preferably maintained within a temperature range that is above the melting point of the polymer but below the activation temperature of foaming agent to prevent premature activation of the foaming agent. Premature activation of the foaming agent in the extruder barrel can result in gas losses and/or create a non-uniform distribution of cells. The proper temperature to maintain in the load zone will depend on various parameters, including the activation temperature for the particular blowing agent used, the size of equipment, and other variables. A temperature range of between about 300° F.-360° F. in the load zone to melt the mixture is optionally maintained.

Once the required amount of mixture is deposited and melted in the barrel, the mixture is pressurized in the compression zone of the barrel in step 220. At or about the same time, the melt is heated in the compression zone to a temperature at or above the activation temperature of the blowing agent in step 225. During this stage, the blowing agent is completely activated to maximize gas yield, with formation of cells being inhibited by the high pressure. Once again, the temperature range used in the compression zone will depend on various parameters, including the activation temperature for the particular blowing agent used, the size of equipment, and other variables. A temperature range of between about 400° F.-480° F. to activate the blowing agent in the compression and metering zones of the barrel is optionally maintained.

The melt is then injected into a mold cavity in step 230. The mold cavity is under a reduced pressure, allowing cell formation to occur in the mold cavity. As noted above, cell formation is preferably commenced after injection into the mold cavity, when the polymer/blowing agent mixture is completely homogenized and distributed throughout the mold cavity. The temperature of the cavity walls is regulated and maintained within a temperature range below the melting temperature of the polymer/blowing agent mixture in step 235. Portions of the melt that flow in proximity to the mold cavity walls are allowed to cool and solidify into solid skin layers in step 240. Meanwhile, the portion of the melt that flows between the skin layers retains a higher temperature while the skin layers are solidified or solidifying, allowing a foamed cellular core to develop between the skin layers in step 245.

Back pressure is maintained in the mold cavity in step 250 until the mixture fills the entire cavity. The pressure in the cavity is then dropped to allow cell formation to continue within the core in step 255. The melt is allowed to cool in step 260 until it hardens completely, after which the cooled article is removed from the mold in step 265.

The temperature and pressure of the polymer/blowing agent mixture are carefully regulated to control the point at which the blowing agent is activated. The timing of the activation of the blowing agent, and the conditions under which it is done, are controlled to achieve a desired size and distribution of cells within the melt. As noted above, the temperature is controlled so that the polymer and blowing agent are admixed at a temperature below the activation temperature of the blowing agent. This facilitates a uniform distribution of blowing agent particles in the melt prior to any cell formation.

The temperature in the barrel may be controlled in a number of ways. Preferably, the barrel temperature is regulated in two or more zones, creating a varying temperature profile. An example of one such temperature profile is summarized below in Table 1, which shows temperature ranges used in different zones of an exemplary injection molding system for the formation of products from polymers such as polypropylene.

TABLE 1
Injection Molding System
Temperature Range Profile

| Load Zone | Compression Zone | Metering Zone | Nozzle | Mold |
|---|---|---|---|---|
| 300° F.–360° F. | 400° F.–440° F. | 440° F.–480° F. | 420° F.–460° F. | 95° F.–120° F. |

As can be observed from Table 1, the temperature is gradually increased from the load zone to the metering zone, the latter zone being of maximum temperature. When the melt is introduced to the nozzle, the temperature is dropped slightly to increase the back pressure to achieve sufficient homogeneity of the molten polymer and blowing agent mixture. This compresses the melt so that in the given combination of melt temperature and pressure, decomposition of the blowing agent is suppressed. The temperature range that is listed for the mold represents the temperature of the cooling water circulated through the mold. A cooling water temperature range of 95° F.-120° F., as noted above, has been found to be cool enough to form the skin layers but not cool enough to solidify the core region of the melt in thin walled parts. Although higher or lower temperatures may be used with satisfactory results, increasing the temperature significantly above 120° F. increases the potential for unsatisfactory skin thicknesses and reduced puncture resistance.

### EXAMPLE

A container was manufactured in accordance with the process described herein, using an admixture containing polypropylene and a chemical foaming agent. The chemical foaming agent was manufactured by Bergen International of Rochelle Park, N.J. under the trademark FOAMAZOL®. The container was removed from an injection mold and analyzed to determine structural characteristics. The wall was scored and snapped open to expose a section of the wall. The exposed wall section was analyzed under magnification to determine characteristics of the skin layer and core layer. The results are summarized in Table 2, below.

TABLE 2
Sample Container

| | |
|---|---|
| Outer skin thickness (in.) | 0.017 |
| Inner skin thickness (in.) | 0.017 |
| Core layer thickness (in.) | 0.027 |
| Avg. cell diameter (in.) | 0.003 |
| Density of outer skin (g/m³) | 0.900 |
| Density of inner skin (g/m³) | 0.900 |
| Density of core layer (g/m³) | 0.739 |
| % Core volume (% of wall volume) | 44.6 |

It has been found that a reduction in weight of the wall section results in a small decrease in puncture resistance. Nevertheless, the reduction in weight was not found to result in a proportional reduction in puncture resistance. For example, foamed container articles associated with a 10% to 13% reduction in weight (as compared with solid-walled containers of equal dimensions) were found to exhibit only a 4% to 5% reduction in puncture resistance.

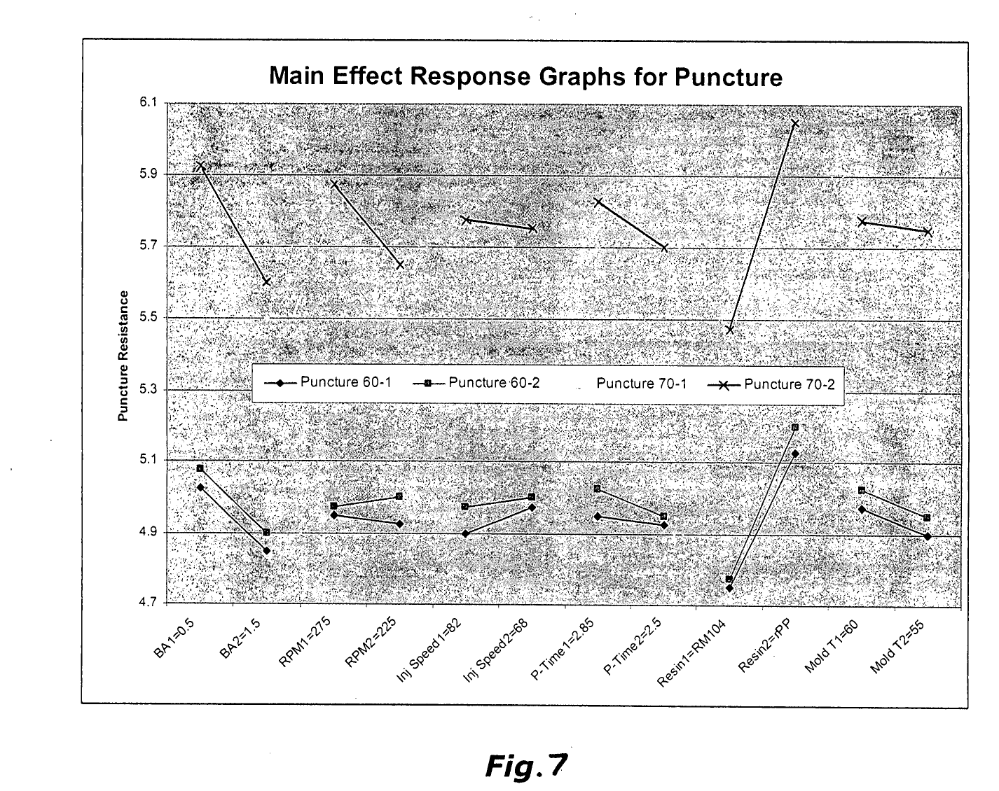

Applicant has performed testing to assess the effect of the presence of a foamed core on the impact resistance of an injection molded part. Results of main effect response graphs for puncture are as illustrated in the chart in FIG. 7.

The chart in FIG. 7 was generated using response data from DOE 06705 and plotted using calculated level averages. The objective of the study was to pick the overall best combination assuming a “Higher-the-Better” principle for all main factors. From FIG. 7, two main factors, blowing agent (“BA”) and Resin, both exhibited strong response. A slight reduction of puncture resistance in specimens with foamed core was observed, as well as elevation of reduction in puncture resistance from specimens with comparatively thinner walls. This effect may be due to an increase in cell size, concentration of cells and allocation. Denser rPP composition can be the cause for the strong increase in puncture resistance. The way the change in the level of BA effects the way Resin factor influences the measured output suggests strong interaction between these two. Physically, there is also a possibility that the rest of the factors were depressed by stronger factors and, being evaluated at the more conservative levels, were offering diminished contrast. From this study, at least one more factor, Mold Temperature, showed some response. Mold Temperature is one of the most influential parameters to cell formation process.

The optimal conditions selected from tested in DOE combinations would be BA %=0.5; Resin=rPP. It would be interesting to estimate expected response and build prediction equation for the case when “Lower-the-Better” principle or criteria is employed for BA factor as well. This is coherent to the main objective of the project to create lighter containers with physical characteristics equal to or better then in original products.

Expected calculated solutions for the Puncture response are presented in Table 3, below. Both versions, optimal condition for tested and overall combination of factors are calculated. Samples made with 1.5% BA content produced lower puncture results by 7.5% and 12.5% compared to the control sample while samples made with 0.5% BA match control performance, yet offer very moderate weight reduction.

TABLE 3
Expected calculated solutions for the Puncture responses.

| | BA (Resin = “Higher-the-Better”) | | | |
|---|---|---|---|---|
| | “Lower-the- | | “Higher-the- | |
| | Better” | | Better” | |
| Y | 0.060 | 0.070 | 0.060 | 0.070 |
| Y′_{opt1–60}Y′_{opt1–70}Y″_{opt1–60}Y″_{opt1–70} | 4.9 | 5.8 | 5.3 | 6.3 |
| Y′_{opt2–60}Y′_{opt2–70}Y″_{opt2–60}Y″_{opt2–70} | 4.9 | 5.6 | 5.3 | 6.5 |
| Y control 101 = RM104 | 5.3 | 6.4 | 5.3 | 6.4 |

The prediction equations are as following:

Y′ₒₚₜ₁₋₆₀=Y′ₒₚₜ₂₋₆₀=5.0+0.1A−0.2B

Y′ₒₚₜ₁₋₇₀=5.8+0.3A−0.3B Y″ₒₚₜ₁₋₇₀=5.8+0.2A+0.3B

Y″ₒₚₜ₁₋₆₀=Y″ₒₚₜ₂₋₆₀=5.0+0.1A+0.2B

Y′ₒₚₜ₂₋₇₀=5.8+0.3A−0.3B−0.1C−0.1F

Y″ₒₚₜ₂₋₇₀=5.8+0.2A+0.3B+0.1C+0.1F

The thickness of the inner and outer skin layers may be formed with equal thicknesses. Alternatively, inner and outer skin layers may be formed with different thickness. For example, the occurrence of a needle puncture through the wall of a sharps container usually originates from the interior of the container where sharps are stored. Therefore, it may be desirable to form a container wall with an inner skin layer that has a greater average thickness than the outer skin layer. The choice of distributing more wall thickness to the inner skin layer may depend on the nature of the waste being placed in the container among other factors. Alternatively, a sharps container may be molded with an outer skin layer that has a greater average thickness than the inner skin layer to provide more impact resistance on the exterior of the container. This may be desired, for example, in smaller containers that are more likely to be dropped by a person carrying the container by hand. The individual wall thickness of the skin layers may be controlled by varying the cooling water temperatures in the mold cavity, so that certain walls of the cavity are cooler than other walls, thereby producing thicker skin layers along those sections of the cavity.

As noted above, the pressure in the mold cavity gradually increases with time after the melt is first injected. Some of this pressure increase results from decomposition of the blowing agent. As pressure in the mold cavity increases, further cell formation and growth may be inhibited. Therefore, the mold cavity is preferably decompressed after a certain hold time so that cell formation and growth can continue. Applicant has been found that decompression of the mold cavity, if not done properly, can adversely affect the shape of ultra-thin walled parts, and can result in warpage or surface irregularities. Opening the mold parts, for example, can have a dramatic impact on the shape of the thin-walled part. Ambient pressure combined with gaseous decomposition pressure inside the skin layers may distort the shape of the thin skin layers. Therefore, conventional methods of depressurizing mold parts, like opening the mold, are not as preferred for use in the present invention.

Applicants have found that decompression of the mold cavity may be carried out without adversely affecting the wall shape by drawing the screw of the injection unit rearwardly after a brief hold time. In particular, the screw of the injection unit may be drawn rearwardly without rotation at a controlled rate and distance. The screw acts like a plunger, creating a small amount of suction that decompresses the mold cavity and allows the material in the mold to continue to expand, without any change to the mold cavity shape itself. The external geometry of the skin layers remains confined to the original mold cavity shape during decompression, substantially preventing distortion and warpage of the skin layers.

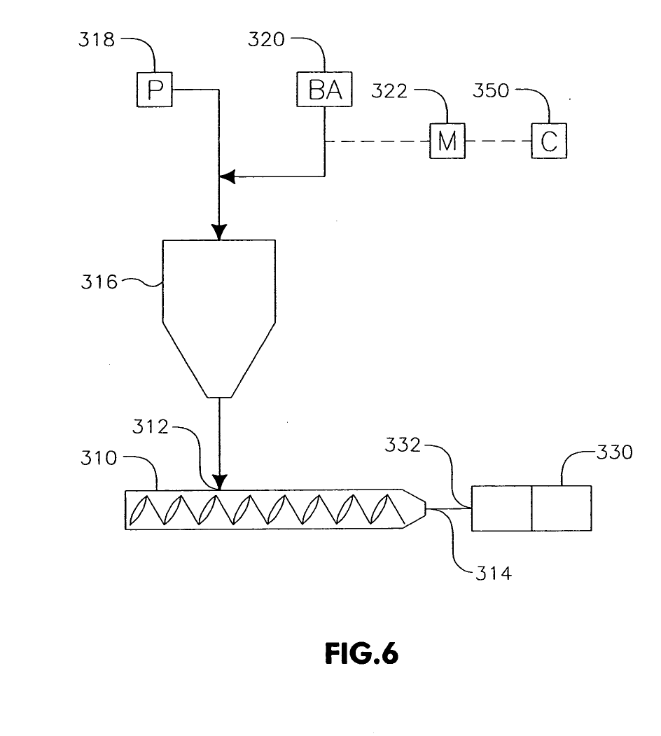

Referring now to FIG. 6, one example of an injection molding system 300 in accordance with the invention is illustrated. Injection molding system 300 includes a barrel 310 having an inlet 312 and an outlet 314. The inlet 312 receives a mixture of polymer and blowing agent from a hopper 316. The hopper 316 feeds a mixture of polymer and blowing agent into the barrel 310 by gravity feed. A source of thermoplastic polymer 318, labeled “P”, deposits a controlled amount of polymer into the hopper 316. In addition, a source of blowing agent 320, labeled “BA”, deposits blowing agent into the hopper 316. Preferably, the blowing agent is metered into the polymer at a controlled rate.

In FIG. 6, a metering device 322, labeled “M”, meters the blowing agent into mixer 316 at a controlled rate. Metering device 322 is connected to a controller 350, labeled “C”. The controller includes a drive motor to control metering of blowing agent in relationship to flow of polymeric material to very precisely control the weight percent of blowing agent in the polymeric mixture. For example, the mass flow rate of the blowing agent can be controlled so that it varies by no more than ±0.3% in preferred cases.

The barrel 310 receives a blend of polymer and blowing agent from the hopper 316. The mixture of polymer and blowing agent are heated and pressurized in the barrel, forming a homogenized melt that is kept under pressure until injection. A molding chamber 330 having an injection port 332 receives the melt.

Thus far, activation of the blowing agent and formation of cells has been described as taking place after injection of the admixture into the mold. In certain instances, it may be desirable to commence cell formation prior to injection, however. According to an alternative system and process of the invention, a reciprocating screw is used to produce either non-microcellular foam or microcellular foam. Where non-microcellular foam is to be produced, the charge that is accumulated in the barrel region can be a multi-phase mixture including cells of blowing agent in polymeric material, at a relatively low pressure. Injection of such a mixture into the mold results in cell growth and production of conventional foam. Where microcellular material is to be produced, a single-phase, non-nucleated solution is accumulated in the barrel region and is injected into the mold while nucleation takes place.

As discussed, conditions can be controlled so as to restrict or control cell growth in a nucleated mixture within the mold. Another use for temperature control measurements is that a portion of the mold wall, or the entire mold wall, can be maintained at a relatively high or relatively low temperature, which can cause relatively greater or lesser cell growth at regions near the wall (regions at and near the skin of the microcellular mold and product) relative to regions near the center of the article formed in the mold.

The preferred system and method allow for rapid, cyclic, polymeric foam molding. After injection and molding, in a period of less than about 10 minutes, a second nucleated mixture can be created by injection into the molding chamber and allowed to foam and solidify in the shape of the enclosure, and to be removed. Preferably, the cycle time is less than about one minute, more preferably less than about 20 seconds, more preferably less than about 10 seconds. The time between introduction of the material into the mold and solidification is typically less than about 10 seconds. Low cycle times are provided due to reduced weight in foam material (less mass to cool), due to endothermic heat absorption by the blowing agent and low melt temperatures made possible by reduced viscosity of a supercritical fluid blowing agent acting as an internal lubricant. Because of these phenomena, less heat absorption is required before part ejection.

The preferred system and method provide the ability to maintain a pressure throughout the system which is adequate to prevent premature nucleation where nucleation is not desirable (upstream of the nucleator), or cell growth where nucleation has occurred but cell growth is not desired or is desirably controlled.

Microcellular polymeric articles or non-microcellular polymeric foam articles can be produced having thicknesses, or cross-sectional dimensions, optionally less than about 0.100 inch, including but not limited to less than about 0.075 inch, less than about 0.050 inch, less than about 0.025 inch, and less than about 0.010 inch, via injection molding, because a single-phase solution of polymer precursor and chemical blowing agent mixture has a particularly low apparent viscosity and, in this manner, can be injected into a mold and formed as a foamed article therein. For example, a single-phase solution of blowing agent and polymer can be introduced into a mold and a conventionally-foamed or microcellular article can be produced thereby. The low viscosity of the melted matrix allows injection-mold cycle times, as described above, of less than 10 minutes, preferably less than 5 minutes, and more preferably less than 1 minute, preferably less than 30 seconds, more preferably less than 20 seconds, more preferably less than 10 seconds, and even more preferably less than 5 seconds.

The preferred system and method also provide for the production of molded microcellular polymeric articles or molded non-microcellular polymeric foam articles of a shape of a molding chamber, including at least one portion having a cross-sectional dimension of less than about 0.075 inch or, in other embodiments, smaller dimensions noted above, the article having a void volume of at least about 5%. Preferably, the void volume is at least about 10%, more preferably at least about 15%, more preferably at least about 20%, more preferably at least about 25%, and more preferably still at least about 30%. In other embodiments, the article has a void volume of at least about 50%. This is a significant improvement in that it is a challenge in the art to provide weight reduction in polymeric material, via foam void volume, in articles having very small lengths and wall thicknesses. The articles of the invention include the above-noted void volumes in sections having total wall thicknesses of less than about 0.075 inch and less. The preferred manufacturing process also provides for the production of molded microcellular polymeric articles or molded non-microcellular foam polymeric articles having a variety of thicknesses and void volumes.

Molded, foamed thermoplastic parts can be produced when the temperature of the melt, mold temperature and blowing agent concentration are optimized to allow the blowing agent to diffuse away from the surface of the part so that the surface includes a skin layer essentially free of cells. This skin layer is essentially solid polymer, thus the part appears as a solid polymeric part to the naked human eye. Splay and a swirl, in foamed polymeric material, is caused by bubbles at the surface being dragged against a mold wall. Where bubbles at the surface are removed, due to temperature control, splay and a swirl is avoided.

In these exemplary embodiments, molded parts are produced having an outer skin of essentially solid polymeric material free of cells, having a thickness at least three times the average cell size of the foam material. Preferably, the outer skin thickness is at least about five times the average cell size of the material. Another reason that molded parts can be produced, according to exemplary embodiments of the invention, that are substantially free of visible splay and a swirl is that the diffusion rate of a supercritical fluid blowing agent is believed to be more rapid than that of typical blowing agents, allowing diffusion at the surface of the article to occur, as described, to form a solid skin layer.

As mentioned, the preferred method provides for the production of molded foam polymeric material, including microcellular material having thin sections. In particular, articles having high length-to-thickness ratios can be produced. Exemplary embodiments of the invention provide injection molded polymeric materials having length-to-thickness ratios of at least about 50:1 where the polymer has a melt index of less than about 10. Preferably the length-to-thickness ratio is at least about 75:1, more preferably at least about 100:1, and more preferably still at least 150:1. In another embodiment an article is provided having a length-to-thickness ratio of at least about 120:1, the polymer having a melt index of less than about 40. In this embodiment, the length-to-thickness ratio is preferably at least about 150:1, more preferably at least 175:1, more preferably at least about 200:1, and more preferably still at least 250:1. Length-to-thickness ratio, in this context, defines the ratio of the length of extension of a portion of a polymeric molded part extending away from the injection location in the mold (nozzle) and the thickness across that distance.

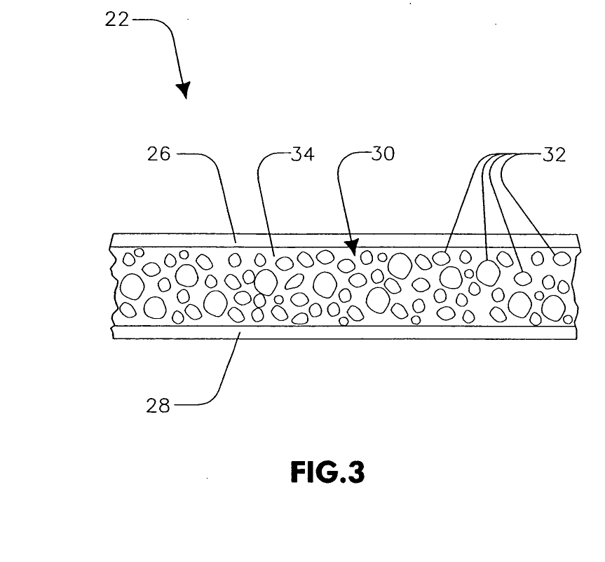

Molding of material provides a skin-foam-skin structure, as shown for example in FIG. 3, which can be controlled based on temperature and other injection conditions to give a thicker or thinner skin. A skin-foam-skin structure has a higher strength-to-weight ratio than a similar part without a skin or with a relatively thin skin. Strength in a skin-foam-skin molded can be calculated partly based upon “I-beam” formulations. However, the applicant is unaware of any prior work that takes into account cell size in the prediction or calculation relating to the strength-to-weight ratio of any skin-foam-skin molded structure.

One advantage of the present invention is that very strong, thin puncture resistant parts can be manufactured. In particular, due to the ability to form very thin foam parts with very small cells, that retain a skin-foam-skin structure, previously impossible with thin foam parts, unexpected tensile strength-to-weight ratios and no significant loss in the puncture resistance in molded materials are achieved. In particular, the present invention provides molded polymeric parts including at least one very thin section, having strength-to-weight ratios (represented as strength-to-density), of at least about 200,000 psi/g/cm³. The thin sections of these parts have a thickness of less than about 0.100 inch, or of less than about 0.075 inch, or of less than about 0.050 inch, and in each of these cases have each of the strength-to-weight ratios described above.

The applicants believe, without limitation to any particular theory, that the unexpected strength-to-weight ratios observed in accordance with the invention are due to maximizing the number of cell walls across a thin section as cell size is minimized. Applicants have not confirmed this to be the reason for the unexpected results, and other factors may play a role. Looking at a cross-section of a thin skin-foam-skin structure with relatively larger cells, relatively fewer cell walls will exist across the structure, and the possibility of one cell bridging the entire foam structure exists. Such a bridge could create a very weak link in the structure. In contrast, in microcellular skin-foam-skin structures according to exemplary embodiments of the present invention, the number of cells (and thus the number of cell walls) across the structure between skin sections is maximized.

The cell walls are analogous to structural support braces or truss members. A cellular polymer matrix provides a substantially uniform strength characteristic across the foam between the skin structures. Thus, while in thin parts of the product the average strength throughout the part may be similar to that of the average strength with a structure having larger cells, articles made according to exemplary embodiments of the present invention are stronger because the point of typical minimum strength representing a cell or void bridging the entire core thickness is eliminated.

Other advantages of the foamed thermoplastic parts include that foamed parts are believed to undergo a greater elastic resistance to deformation without failure than do corresponding non-foamed parts, have improved compressive properties and have weight reductions up to 50% by weight, based on the corresponding non-foamed part. The unexpected puncture resistance of the foamed parts is likely due in part to the greater amount of deformation permitted in the foamed part, because the wall surface is capable of flexing when a sharp object impacts the surface of the foamed part, thereby resisting penetration by absorbing some of the force.

Using the preferred system and method of the invention, articles can be produced that are opaque without the use of opacifiers. This is because polymeric foam diffracts light, thus it is essentially opaque and has a white appearance. Microcellular foams are more opaque, and uniformly so, than conventional foams. This is a significant advantage in connection with articles constructed and arranged to contain material that is subject to destruction upon exposure to light, such as food containers. Such material can alternatively involve medical waste and sharps containers. While opacifiers such as pigments are typically added to articles, pigmented material is less amenable to recycling. The present invention optionally provides thin, opaque articles that include less than about 1% by weight auxiliary opacifer, preferably less than about 0.05% by weight auxiliary opacifer, and more preferably still material that is essentially free of auxiliary opacifer. “Auxiliary opacifer”, as used herein, is meant to define pigments, dyes, or other species that are designed specifically to absorb light, or talc or other materials that can block or diffract light. Those of ordinary skill in the art can test whether an additive is an opacifer. Microcellular blow molded articles of the invention have the appearance of essentially solid, white, plastic articles, which offers significant commercial appeal.

Numerous variations, changes and substitutions will occur to those skilled in the art without departing from the spirit of the invention. For example, the invention may apply to any motive or stationary molded component of a medical waste disposal system. Furthermore, this invention may be applicable to any molded article, upon the surface of which an object slides, translates, or rolls, such as a playground slide, for example. Accordingly, it is intended that the appended claims cover all such variations as fall within the spirit and scope of the invention.

What is claimed:

1. A medical waste container comprising a wall and at least one reduced-weight section of the wall formed of a foamed thermoplastic polymer, the at least one reduced-weight section of the wall comprising an outer skin layer, an inner skin layer, and a cellular core layer between the outer skin layer and inner skin layer, the cellular core layer having a density lower than a density of the outer skin layer and a density of the inner skin layer, the reduced-weight section of the wall having a needle puncture resistance of at least about 2.8 lbf.

2. The container according to claim 1, wherein the reduced-weight section of the wall has a needle puncture resistance of at least about 3.4 lbf.

3. The container according to claim 1, wherein the outer and inner skin layers have a thickness of between about 0.005 in. to about 0.1 in.

4. The container according to claim 1, wherein the core layer has a thickness of between about 0.025 in. to about 0.05 in.

5. The container according to claim 1, wherein the core layer has a thickness of between about 0.03 in. to about 0.04 in.

6. The container according to claim 1 wherein said at least one reduced-weight section comprises a skin/core/skin thickness ratio of between about 1:10:1 to about 1:1:1.

7. The container according to claim 1, wherein said at least one reduced-weight section comprises a skin/core/skin thickness ratio of 3:5:3.

8. The container according to claim 1 wherein said at least one reduced-weight section has a total thickness of about 0.07 in.

9. The container according to claim 1, comprising at least one additive selected from the group consisting of: stabilizers, pigments, coloring agents, fillers, nucleating agent, fire-retarding agents, antistatic agents, lubricants, non-stick agents, and mixtures thereof.

10. The container according to claim 1, wherein said at least one reduced-weight section has a reduced weight percentage of at least about 10%.

11. The container according to claim 1, wherein said at least one reduced-weight section exhibits no warping.

12. The container according to claim 1, wherein said at least one reduced-weight section has a needle puncture resistance of between about 2.8 lbf to about 7.0 lbf.

13. A method for manufacturing a medical waste container comprising the steps of:
(a) combining a thermoplastic polymer with an endothermic chemical blowing agent;
(b) heating the polymer and blowing agent to form a melted mixture;
(c) maintaining the mixture under conditions that substantially prevent activation of the blowing agent;
(d) injecting the mixture into a mold chamber of a mold;
(e) maintaining the mold chamber at a pressure that is sufficiently low to promote cell growth in the mold chamber; and
(f) cooling the melted mixture in the mold to form skin layers in the mold, wherein the cell formation occurs between the skin layers to form a cellular core layer between the skin layers.

14. The method according to claim 13, further comprising the step of initiating decomposition of the blowing agent at the entrance of the mold cavity.

15. The method according to claim 13, further comprising the step of maintaining the chamber walls at a temperature below the melting point of the mixture.

16. The method according to claim 14, wherein the step of maintaining the chamber walls at a temperature below the melting point of the mixture comprises maintaining the chamber walls at a substantially constant temperature of between about 80° F. and about 125° F.

17. The method according to claim 14, wherein the step of maintaining the chamber walls at a temperature below the melting point of the mixture comprises maintaining the chamber walls at a substantially constant temperature of between about 95° F. and about 120° F.

18. The method according to claim 13, wherein the step of injecting the mixture into the mold chamber comprises injecting the mixture at an injection velocity of between about 0.025 in./sec. and about 25.0 in./sec.

19. The method according to claim 13, further comprising the step of reducing the pressure in the mold chamber after injection of the mixture into the mold chamber to promote cell formation in the core layer.

20. The method according to claim 13 further comprising the step of combining the thermoplastic polymer and the endothermic chemical blowing agent with at least one additive selected from the group consisting of: stabilizers, pigments, coloring agents, fillers, nucleating agent, fire-retarding agents, antistatic agents, lubricants, non-stick agents, and mixtures thereof.

21. The method according to claim 13 wherein the step of cooling the mixture in the mold chamber to form skin layers in the mixture comprises the step of forming a first skin layer and a second skin layer having a thickness greater than the first skin layer.
